(19) United States
(12) Patent Application Publication
(10) Pub. No.: US 2007/0079722 A1
(43) Pub. Date: Apr. 12, 2007

(54) Chemiluminescent paint projectiles and method and preparation

(75) Inventor: W. Wesley Parish, Orem, UT (US)

Correspondence Address: HOLLAND & HART LLP, 60 E. SOUTH TEMPLE, SUITE 2000, SALT LAKE CITY, UT, 84111, US

(73) Assignee: The Sepron Company, L.C.

(21) Appl. No.: 10/576,625

(22) PCT Filed: Oct. 21, 2004
(86) PCT No.: PCT/US04/34713

§ 371 Date: Apr. 21, 2006

Related U.S. Application Data
(60) Provisional application No. 60/513,088, filed on Oct. 21, 2003.

(51) Int. Cl. A63F 9/02; F42B 12/00; C09K 3/00

(52) U.S. Cl. 102/513; 273/317; 252/700

(57) ABSTRACT

Chemiluminescent agents in combination with filler materials useful for projectiles are disclosed. Methods for making paint balls and playing in low light exercises are also disclosed.

### PRIORITY CLAIM

This application claims the benefit of the filing date of U.S. Provisional Patent Application Ser. No. 60/513,088, filed Oct. 21, 2003, for CHEMILUMINESCENT PAINT PROJECTILES AND METHOD OF PREPARATION.

### TECHNICAL FIELD OF THE INVENTION

The present invention relates to autoxidative chemiluminescent compositions and projectiles, methods of making the projectiles, and paintball exercises that implement the chemiluminescent composition containing projectiles.

### BACKGROUND

Paintball projectiles have been used in a various applications including the marking of trees during lumbering operations, and, more recently in recreational war games, as well as police and military training.

A luminescent paint ball projectile for marking night time targets was introduced by Henry J. Smith (see U.S. Pat. Nos. 5,001,880 and 5,018,450). The subject projectiles of those disclosures were formed and filled in double fused hemispherical chambers, which were not amenable to production using standard paint ball manufacturing machinery but rather required special tooling and encapsulating equipment. The two hemispheres were filled with oxalate ester components, one hemisphere being filled with a hydroperoxide solution plus fluorescent compound and the other with the oxalate ester fuel composition. The peroxyoxalate ester components, particularly the negatively substituted oxalate esters are incompatible with many of the commonly used encapsulating components leading to poor product shelf life. Martinez in WO 02/077562 describes projectiles containing chemiluminescent compounds incorporating one or more spheres within the projectile which when ruptured allow a reaction. However, there is significant difficulty in manufacturing such projectiles.

Robeson in U.S. Pat. No. 5,967,916 describes luminescent projectiles with systems of fluorescent dyes or a phosphorescent composition that glows when illuminated with incident black light radiation. U.S. Pat. Nos. 6,082,349 and 6,298,841 incorporate phosphorescent pigments. Phosphorescence is a relatively short lived, inefficient process which requires charging by exposure to bright light prior to use. The charge-up process requires either special charging equipment, which is retrofitted to existing guns, or special charging equipment independent of the gun, where the balls may be separately charged prior to use. Such charges require a power source and when retro fitted to existing guns, prove inconvenient and unwieldy in use. Incorporating different phosphors with other dyes and pigments gives light outputs of different colors. Once the projectiles are charged however, the light emission is fixed by the natural decay curve of the inherent phosphorescence process.

### SUMMARY OF THE INVENTION

The invention includes projectiles which illuminate a target on impact comprising an autoxidative chemiluminescent agent, a solvent and a single chamber frangible shell surrounding the chemiluminescent agent and the solvent so that upon impact the chemiluminescent agent is dispersed to react with an oxidation source. Chemiluminescent agents includes those compounds of Formulas I-IX,. 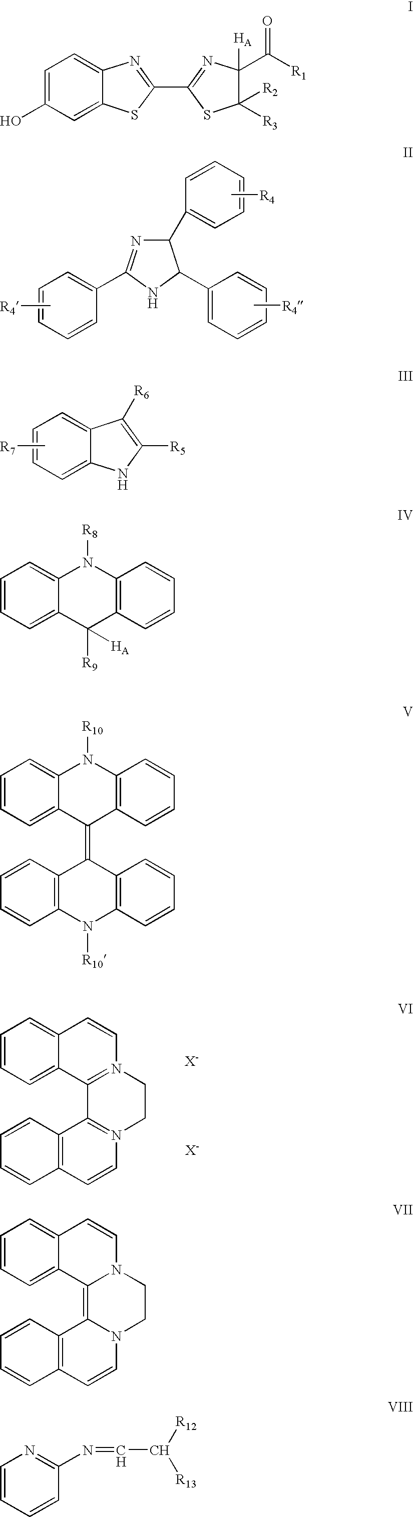 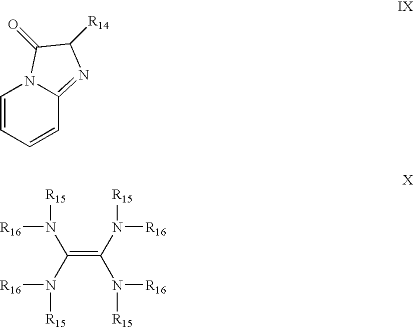
in which the individual groups or radicals have the following meanings:

R₁ may be a leaving group which in its protonated form has an acid constant (pKa) of 1×10⁻⁹ or greater but not aliphatic esters;

R₂ may be H, and C₁-C₁₂ hydrocarbon including linear, branched, or cyclic hydrocarbon, aryl, benzyl, unsaturated hydrocarbon, alkoxyl, or halogen but halogen does not include iodine;

R₃ may be H, and C₁-C₁₂ hydrocarbon including linear, branched, or cyclic hydrocarbon, aryl, benzyl, unsaturated hydrocarbon, alkoxyl, or halogen but halogen does not include iodine;

each R₄ may independently be H, C₁-C₁₂ alkyl including linear, branched, or cyclic alkyl, C₁-C₁₂ alkoxyl including linear, branched, or cyclic alkoxyl, cyano, C₁-C₁₂ carboxy esters, C₁-C₁₂ ketones, or halogen except that halogen does not include iodine, and R4 cannot be nitro;

R₅ may be H, C₁-C₁₂ alkyl including linear, branched, or cyclic alkyl or aryl;

R₆ may be H, C₁-C₁₂ alkyl including linear, branched, or cyclic alkyl or aryl;

R₇ may be H, C₁-C₁₂ alkyl including linear, branched, or cyclic alkyl, aryl, C₁-C₁₂ alkoxy, or halogen but halogen may not be iodine, and R₇ cannot be nitro;

R₈ may be H, aryl, C₁-C₁₂ alkyl including linear, branched, or cyclic alkyl;

R₉ may be cyano or ester of the formula —COZ wherein Z may be a leaving group which in its protonated form has an acid constant (pKa) of 1×10⁻⁹ or higher, preferably 1×10⁻⁶ or higher. Several such leaving groups are known in the art and by way of illustration may include phosphate, phenol, thiophenol, aryl esters, and various heterocycles, but R₈ may not be aliphatic esters;

each R₁₀ may independently be H, C₁-C₁₂ alkyl including linear, branched, cyclic alkyl, or aryl;

R₁₂ may be H, C₁-C₁₂ alkyl including linear, branched, cyclic alkyl, or aryl;

R₁₃ may be H, C₁-C₁₂ alkyl including linear, branched, cyclic alkyl, or aryl;

R₁₄ may be H, C₁-C₁₂ alkyl including linear, branched, cyclic alkyl, or aryl;

R₁₅ may be C₁-C₁₂ alkyl including linear, branched, or cyclic alkyl; and,

R₁₆ may be C₁-C₁₂ alkyl including linear, branched, or cyclic alkyl.

In some embodiments, the chemiluminescent agent is tetrakis(pyrrolidinyl)ethylene. In some embodiments the solvent is selected from mineral oil, polyethylene glycol, silicone oil, vegetable oil and mixtures of the foregoing. In some embodiments, the projectile includes any one or more of an activator, a pigment, a surfactant, a thickening agent and a fragrance.

In many embodiments, the chemiluminescent agent is capable of a luminescent quantum yield in the range of 1 to 0.00001 Einsteins per mole. In many embodiments, the chemiluminescent agent is capable of a luminescent quantum yield in the range of 1 to 0.001 Einsteins per mole.

In many embodiments, a projectile consisting of single frangible chamber, wherein the chamber contains ingredients comprising an autoxidative chemiluminescent agent and a solvent is disclosed. In some embodiments, the autoxidative chemiluminescent agent reacts with atmospheric oxygen upon impact with a target.

The invention also includes a method for manufacturing a luminescent projectile comprising the steps of preparing a fill material, the fill material comprising a chemiluminescent substrate and a solvent, preparing a frangible shell, and filling the frangible shell with the fill material.

Another method of the invention is marking an object by impacting a target with a frangible projectile that breaks upon impact releasing a chemiluminescent substrate to expose the chemiluminescent substrate to an oxidation source. In some embodiments, the method includes an oxidation source that is contained in the projectile in a first compartment reactively separate from the chemiluminescent substrate, wherein the first compartment becomes reactively connected to the chemiluminescent substrate upon impact. In some embodiments, the oxidation source is selected from the group consisting of hydrogen peroxide, alkyl peroxide and aryl peroxide.

Another method of the invention includes a method of playing a paintball game by dividing two or more people into a first team and second team of players wherein each player has a marker for discharging paintballs, the paintballs comprising a chemiluminescent agent, a solvent; and a shell surrounding the chemiluminescent agent and the solvent, providing a playing surface with a first point and a second point, positioning the first team near the first point, the first team having the objective to score points by marking players of the second team, positioning the second team near the second point, the second team having the objective to score points by marking players of the first team, awarding a point value to the first team each time a player from the first team marks a player from the second team and awarding a point value to the second team each time a player from the second team marks a player from the first team, and, determining a winning team based on which of the first team and the second team accumulates the largest point total over a predetermined game time.

In another method of the invention, a game of paint ball includes using a single chamber shell with an auto oxidative chemiluminescent agent.

Compositions for chemiluminescence of the invention are those comprising a chemiluminescent agent of from about 5% to about 10%, a wax of from about 2% to about 5%, a pigment of from about 0% to about 10%, a fragrance additive of from about 0% to about 3%, an organic alcohol of from about 0% to about 3%, a hydrophobic solvent of from about 70% to about 90%, and, a surfactant of from about 0% to about 3%.

### DETAILED DESCRIPTION

The present invention provides improved paintball projectiles that avoid the disadvantages of the prior products.

### Definitions

“Paint ball” is a term used to describe a game played by numerous game formats from simple indoor target shooting to wide ranging war games involving multiple teams of participants deployed over relatively large expanses of natural terrain. Sometimes the term “paint ball” is used to describe the round or semi round projectile used in the game of paint ball.

Luminescence is a phenomenon which occurs when energy is produced in the form of visible light. The term “luminescence” as used herein means “spontaneous emission of radiation from an electronically or vibrationally excited species not in thermal equilibrium with its environment.” Luminescence can arise in a variety of forms including bioluminescence, chemiluminescence, electro-generated chemiluminescnece, fluorescence, phosphorescence, photoluminescence, radioluminescence, sono luminescence, thermoluminescence, triboluminescence. Luminescence may be represented as follows:
X*→X+hv
where X* is an electronically excited molecule and hv represents light emission upon return of X* to a lower energy state.

The term “chemiluminescence” as used herein means emission of radiation from a chemical reaction. The emitting species may be a reaction product or a species excited by energy transfer from an excited reaction product. The excitation may be electronic, vibrational or rotational. Chemiluminescence is a phenomenon which occurs when one or more chemicals react in a way that produces energy at or near ambient temperatures in the form of visible light. This visible light is usually more visible in the dark. This form of light production is sometimes referred to as “cold light.” Chemiluminescence may be represented as follows
A+B→X+Y
X*→X+hv
where again X* is an electronically excited molecule and hv represents light emission upon return of X* to a lower energy state.

The term “autoxidation” or “auto oxidation” means the oxidation of a substance by its direct combination at ambient temperatures with oxygen, usually but not necessarily from exposure to atmospheric oxygen in air.

The term “projectile” as used herein means an article launched toward a target that leaves a visible mark on the target. In the sport of paint ball, the projectile is sometimes referred to as a paint ball.

The term “marker” or “projectile launching device” as used herein means devices used in paint ball games or other applications to launch projectiles at an intended target. A typical projectile will be launched with a compressed gas paint ball gun, or blowgun.

The term “component” as used herein means a material or chemical that is used in the preparation or manufacture of a projectile.

The term “fill composition” or “fill material” as used herein means the liquid, solid or liquid-solid suspension that is used on the interior of a paint ball. An outer shell to keep its contents from leaking usually surrounds the fill composition or material.

The term “shell material” as used herein means the frangible outer shell of a paint ball. The shell is usually constructed from a polymeric material such as gelatin, or polyvinyl alcohol in such a way to maintain a hard outer surface, which is frangible enough to burst open on contact with a hard surface after being launched by a projectile launch device.

The term “frangible” as used herein, as used herein means capable of fracturing on impact with a target.

The term “alkyl” as used herein means a straight or branched hydrocarbon radical or group having at least one carbon atom including but not limited to saturated C₁-C₆ such as methyl, ethyl, 1-propyl and 2-propyl, 1-butyl, 2-butyl, 2-methyl-1-propyl, 1,1-dimethylethyl, 1-pentyl, 2-pentyl, 3-pentyl, 2-methyl-1-butyl, 3-methyl-1-butyl, 2,2-dimethylpropyl, 1-hexyl, 2-hexyl, 3-hexyl, 2-methyl-1-pentyl, 3-methyl-1-pentyl, 4-methyl-1-pentyl, 3,3-dimethyl-1-butyl, 3,3-dimethyl-2-butyl, 2-ethyl-1-butyl and the like; C₇-C₁₂ such as 1-heptyl, 2-heptyl, 3-heptyl, 4-heptyl, 2-methyl-1-hexyl, 4-methyl-1-hexyl, 5-methyl-1-hexyl, 1-octyl, 2-octyl, 3-octyl, 4-octyl, 6-methyl-1-heptyl, 5,5-dimethyl-1-hexyl, 2-ethyl-1-hexyl, 2-methyl 1-1-heptyl, 2-propyl-1-pentyl, 1-nonyl, 2-nonyl, 2-ethyl-2-methyl-1-hexyl, 4-methyl-1-octyl, 3,5,5-trimethyl-1-hexyl, 1-decyl, 2-decyl, 4-ethyl-1-octanyl, 2-methyl-1-nonyl, 4-methyl-1-nonyl, 8-methyl-1-nonyl, 1-undecyl (1-hendecyl), 2-undecyl, 7-methyl-1-decyl, 1-dodecyl, 5-dodecyl, 2-butyl-1-octyl, 10-methyl-1-undecyl and the like.

The term “unsaturated hydrocarbon” as used herein means alkyl groups having two or more carbons with 1 or more sites of unsaturation, the groups being known as alkenyl groups or radicals and alkynyl groups or radicals. Alkenyl groups are analogous to alkyl groups which are saturated, but have at least one double bond (two adjacent sp² carbon atoms). Depending on the placement of a double bond and substituents, if any, the geometry of the double bond may be trans (E),or is (Z). Similarly, alkynyl groups have at least one triple bond (two adjacent sp carbon atoms). Unsaturated alkenyl or alkynyl groups may have one or more double or triple bonds, respectively, or a mixture thereof. Like alkyl groups, unsaturated groups may be straight chain or branched. Examples of alkenyls include vinyl, allyl, 2-methyl-2-propenyl, cis-2-butenyl, trans-2-butenyl, and acetyl, propene, 1-butene, 2-butene, 2-methylpropene, 1-pentene, 2-petnene, 2-methyl-1-butene, 2-methyl-2-butene, 3-methyl-1-butene, 1-hexene, 2-hexene, 3-hexene, 2,3-dimethyl-1-butene, 2,3-dimethyl-2-butene, 3,3-dimethyl-1-butene, 2-dimethyl-2-butene, 2-ethyl-1-butene, 2-methyl-1-pentene, 2-methyl-2-pentene, 3-methyl-1-pentene, 3-methyl-2-pentene, 4-methyl-1-pentene, 4-methyl-2-pentene, 1-heptene, 2-heptene, 3-heptene, 3,4-dimethyl-2-pentene, 4,4-dimethyl-2-pentene, 3-methyl -2-hexene, 3-methyl -3-hexene, 4-methyl -2-hexene, 2,3-dimethyl-1-pentene, 2,3-dimethyl-2-pentene, 2,4-dimethyl-1-pentene, 2,4-dimethyl-2-pentene, 3,3 -dimethyl-1-pentene, 3,4-dimethyl-1-pentene, 4,4-dimethyl-1-pentene, 4,4-dimethyl-2-pentene, 3-ethyl-1-pentene, 3-ethyl-2-pentene, 2-methyl-1-hexene, 2-methyl -2-hexene, 3-methyl-1-hexene, 4-methyl-1-hexene, 5-methyl-1-hexene, 2,3,3-trimethyl-1-butene, 1-octene, 2-octene, 3-octene, 4-octene, 2,2-diemethyl-3-hexene, 2,3-dimethyl-2-hexene, 2,3-dimethyl -3-hexene, 3-ethyl-2-methyl-1-pentene, 3-ethyl-2-methyl-pent-2-ene, 2-isopropyl-1-pentene, 2-methyl-1-heptene, 2-methyl-2-heptene, 4-methyl-2-heptene, 2,3,4-trimethyl-2-pentene, 2,4,4-trimethyl-1-pentene, 2,4,4-trimethyl-2-pentene, 3,4,4-trimethyl-2-pentene, 1-nonene, 2-nonene, 3-nonene, 4-nonene, 2,2-dimethyl-3-heptene, 3,5,5-trimethyl-1-hexene, 1-decene, 4-decene, 5-decene, 3,7-dimethyl-1-octene, 2-methyl-1-nonene, 1-undecene, trisisobutylene, 2,2,4,6,6-pentamethyl-3-heptene, 1-dodecene, 2-methyl-1-undecene, and the like.

Examples of dialkenes include but are not limited to propandiene (allene), 1,3-butadiene, 1,3-pentadiene, 1,4-pentadiene, 2-methyl-1,3-butadiene(isoprene), 3-methyl-1,2-butadiene, 1,3-hexadiene, 1,4-hexadiene, 1,5-hexadiene, 2,4-hexadiene, 2,3-dimethyl-1,3-butadiene, 2-methyl-1,3-pentadiene, 2-methyl-1,4-pentadiene, 3-methyl-1,4-pentadiene, 4-methyl-1,3-pentadiene, 3-methyl-1,3-pentadiene 1-heptyne, 2-heptyne, 3-heptyne, 2,4-dimethyl-1,3-pentadiene, 2,4-dimethyl-2,3-pentadiene, 1,6-heptadiene, 1,7-octadiene, 1,4-octadiene, 3-methyl-1,5-heptadiene, 2,5-dimethyl-1,5-hexadiene, 2,5-dimethyl-1,4-hexadiene, 1,8-nonadiene, 7-methyl-1,6-octadiene 1,9-decadiene, 7-dimethyl-1,6-octadiene, 5,7-dimethyl-1,6-octadiene 1,7-hexadecadiene and the like.

Examples of trialkenes include but are not limited to 5-methyl-1,3,6-heptatriene, 2,6-dimethyl-2,4,6-octatriene (neo-alloocimene), 1,5,9-decatriene, 2,6-dimethyl-2,4,6-octatriene, 3,7-dimethyl-1,3,6-octatriene, 7-methyl-3-methylene-1,6-octadiene, 3,7-dimethyl-1,3,6-octatriene, 1,4,9-decatriene, 1,3,5-undecatriene and the like. Examples of alkynyls include, but are not limited to 1-butyne, 2-butyne, 1-pentyne, 2-pentyne, 4-methyl-pent-1-yne, 1-hexyne, 2-hexyne, 3-hexyne, 3,3-dimethyl-1-butyne, 1-heptyne, 2-heptyne, 3-heptyne, 5-methyl-1-hexyne, 1-octyne, 2-octyne, 3-octyne, 4-octyne, 1-nonyne, 1-decyne, 5-decyne and 1-dodecyne, and the like. Alkenyl and alkynl groups may be unsubstituted or substituted.

An unsaturated hydrocarbon may also include subunits of double bonds and subunits of triple bonds. Examples of these mixed alkenyl and alkynl groups include 2-methyl-1-buten-3-yne, 2-methyl-1-hexen-3-yne and the like. Mixed alkenyl and alkynl groups may be unsubstituted or substituted.

Alkyl also includes groups having three or more carbons that contain 1 or more sites of unsaturation, that group being known as cycloalkyl groups or radicals.

The terms “cycloalkyl” and “cyclic alkyl” as used herein means a monocyclic or polycyclic hydrocarbyl group. Illustrative examples of a cycloalkyl group or radical include cyclopropyl, cycloheptyl, cyclooctyl, cyclodecyl, cyclobutyl, adamantyl, norpinanyl, decalinyl, norbornyl, cyclohexyl, and cyclopentyl. Cycloalkyl groups may be unsubstituted or substituted. Also included are rings in which 1 to 3 heteroatoms replace carbons. Such groups are termed “heterocyclyl”, which means a cycloalkyl group also bearing at least one heteroatom selected from O, S, or N, examples being oxiranyl, pyrrolidinyl, piperidyl, tetrahydropyran, and morpholine.

The term “aryl” as used herein means an aromatic carbocyclic ring having from 6 to 14 carbon atoms. Illustrative examples of an aryl group or radical include phenyl, 1-naphthyl, 2-naphthyl, I-anthryl, 2-antrhyl, 9-anthryl, 1-phenanthryl, 2-phenanthryl, 3-phenanthryl, 4-phenanthryl, 5-phenanthryl, and the like; including fused ring systems with rings that have less than 6 carbons such as 1-acenaphthyl, 3-acenaphthyl, 4-acenaphthyl, 5-acenaphthyl, 1-azulyl, 2-azulyl, 4-azulyl, 5-azulyl, 6-azulyl and the like. Aryl groups may be unsubstituted or substituted.

The term “heteroaryl” as used herein means an unsaturated monocyclic group or radical of 5 or 6 atoms, an unsaturated fused bicyclic group or radical of from 8 to 10 atoms, or an unsaturated fused tricyclic group or radical of from 11 to 14 atoms, the cyclic groups having 1 or 2 heteroatoms independently selected from O, N, or S. Illustrative examples of monocyclic heteroaryl include 2-or 3-thienyl, 2-or 3-furanyl, 1-, 2-, or 3-pyrrolyl, 1-, 2-, or 4-imidazolyl, 1-, 3-, or 4-pyrazolyl, 2-, 4-, or 5-oxazolyl, 2-, 4-, or 5-thiazolyl, 3-, 4-, or 5-isoxazolyl, 3-, 4-, or 5-isothiazolyl, 2-, 3-, or 4-pyridinyl, 3-or 4-pyridazinyl, 2-or 3-pyrazinyl, and 2-, 4-, or 5-pyrimidinyl. Illustrative examples of bicyclic heteroaryl include 2-, 3-, 4-, 5-, 6-, 7-, or 8-quinolinyl, 1-, 3-, 4-, 5-, 6-, 7-, or 8-isoquinolinyl, 1-, 2-, 3-, 4-, 5-, 6-, or 7-indolyl, 2-, 3-, 4-, 5-, 6-, or 7-benzo[b]thienyl, 2-, 4-, 5-, 6-, or 7-benzofuran, 2-, 4-, 5-, 6-, or 7-benzoxazolyl, 2-, 4-, 5-, 6-, or 7-benzothiazolyl, and 1-, 2-, 3-, 4-, 5-, 6-, or 7-benzimidazolyl. Illustrative examples of tricyclic heteroaryl include 1-, 2-, 3-, or 4-dibenzofuranyl, 1-, 2-, 3-, or 4-dibenzothienyl, and 1-, 2-, 3-, 4-, 5-, 6-, 7-, 8-, or 9-(1,2,3,4-tetrahydroacridinyl). Heteroaryl groups may be unsubstituted or substituted.

As used above, a fused bicyclic group or radical is a group wherein two ring systems share two and only two atoms. As used above, a fused tricyclic group or radical is a group wherein three ring systems share four and only four atoms.

The term “alkoxyl” as used herein means linear or branched oxy-containing radicals each having alkyl portions of one to about ten carbon atoms, such as methoxy and ethoxy groups.

The present invention relates to luminescent projectiles based on chemiluminescent autoxidation systems suitable for use with projectile launchers such as compressed gas powered guns to fire paint balls, and in particular, chemiluminescent systems that react with atmospheric oxygen or are air activated.

A single compartment autooxidative chemiluminescent projectile suitable for use in compressed gas operated launching devices such as paint ball markers will preferably satisfy the following criteria. First, an autoxidative chemiluminescent system will include an oxidant, which reacts with a fuel to generate a substantial population of excited state emitters such as first singlet excited state emitters. Generally, the fuel component will be maintained separately out of contact with the oxidant until the light-generating reaction is desired. When the light is desired, the fuel is mixed with the oxidant and light is produced. Atmospheric air is about 20 percent oxygen and that oxygen is capable of acting as oxidant in autoxidative chemiluminescent systems of the invention. While the process referred to as chemiluminescent autoxidation has been practiced in some contexts, light outputs are generally not of any practical utility. Single compartment chemiluminescent projectiles require a relatively efficient chemiluminescent autoxidation process with defined light outputs in the range of 1 to 1×10⁻⁵ Einsteins per mole, preferably 1 to 1×10⁻³ Einsteins per mole to be usable.

Second, chemiluminescent autoxidation systems can be sensitive to a number of substances that reduce or quench light outputs to the point where the light output is of little or no utility. Quenchers and inhibitors may be acids, bases, oxidizable or reducible transition metals, salts, water, oxygen, common solvents and polymers. Each chemiluminescent autoxidation system will have its own unique set of compatibility requirements recognizable by one skilled in the art, which will limit capsule filling formulations. A selected chemiluminescent autoxidation system should be combined with appropriate non-reactive compatible ingredients, which produce a suitable target marking composition.

Third, the fill composition, including the chemiluminescent autoxidation system, should be compatible with all of the ingredients used in the encapsulation system. The interior walls of the capsule forming the projectile should not react with or be incompatible with the fill material.

Fourth, the outer capsule wall of the projectile should be compatible with conditions and elements found in the environment such as heat, light, oxygen, water, and reasonable incidental impacts. The capsule should be capable of protecting its contents from the effects of these forces and elements, particularly, exposure to oxygen. The finished capsule should be suitable for use in projectile launchers such as compressed gas operated projectile launchers to fire paint balls. The capsules should also possess the characteristics and qualities that have been found desirable in commonly used projectiles such as paint balls. The finished paint ball should be frangible. The projectiles should not swell or otherwise deform on exposure to environmental conditions and should have favorable ballistics. The fill material should leave a uniform impact pattern of 2 to 5 inches (5.08 cm-12.7 cm) in diameter, which adheres to the target surface without undue running. The marking material should be water washable, safe, non-toxic, and environmentally harmless.

The simultaneous satisfaction of these requirements can be achieved by one skilled in the art recognizing component compatibilities and the selection of suitable ingredients that satisfy many or all of the requirements for projectiles of the invention.

Single compartment autoxidation systems have a number of advantages over other luminescent projectile systems. The single component systems do not require specially constructed multi-compartment capsules or special manufacturing equipment. Projectiles can be manufactured by simply substituting the chemiluminescent fill material for the standard fill material in an existing production line. Autoxidation chemiluminescent projectiles do not require black light background lighting and can be used in wide ranging outdoor pursuit activities. Chemiluminescent projectiles can be used without charging prior to use and without expensive and cumbersome retrofit attachments on existing compressed gas driven projectile launchers.

The autoxidative chemiluminescent projectiles, which are the subject of this invention, can utilize filler materials and compositions already known in the art provided that the compositions do not contain materials that seriously quench the light output or are otherwise incompatible with the autoxidation components. Standard encapsulating materials may also be used so long as they are not incompatible with other system components. Each autoxidation system may have compatibility requirements such that one skilled in the art would appreciate that fill formulations and other system components should not significantly degrade the autoxidative chemiluminescent agent.

In one aspect of the invention, frangible projectiles which illuminate a target on impact comprise a single compartment an autoxidative chemiluminescent agent, a solvent and a single chamber shell surrounding the chemiluminescent agent and the solvent are disclosed Luminescent autoxidation system satisfying the minimum light output requirements of 1 to 1×10⁻⁵ Einsteins per mole, preferably 1 to 1×10⁻³ Einsteins per mole with adequate air reactivity to release its light capacity in seconds to a few hours, could be used. In one aspect of the invention, compounds useful in producing output light requirements are disclosed. The following compounds of Formula I may be used as the chemiluminescent agent:

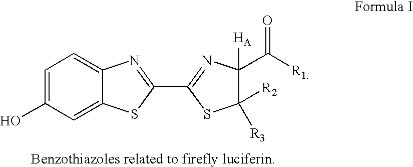

R₁ may be a leaving group which in its protonated form has an acid constant (pKa) of 1×10⁻⁹ or higher, preferably 1×10⁻⁶ or higher. Several such leaving groups are known in the art and by way of illustration may include phosphate, phenol, thiophenol, aryl esters, and various heterocycles. R₁ may not be aliphatic esters.

When R₁ is hydroxy and the hydroxyl is further functionalized by enzymatic phosphorylation with adenosine triphosphate, enzymatically catalyzed oxidation reactions yield higher light outputs than simple base catalyzed reactions with oxygen.

R₂ may be H, and C₁-C₁₂ hydrocarbon including linear, branched, or cyclic hydrocarbon, aryl, benzyl, unsaturated hydrocarbon, alkoxyl, or halogen but halogen does not include iodine.

R₃ may be H, and C₁-C₁₂ hydrocarbon including linear, branched, or cyclic hydrocarbon, aryl, benzyl, unsaturated hydrocarbon, alkoxyl, or halogen but halogen does not include iodine.

The benzothiazoles (Formula I) related to firefly luciferin are operable with or without firefly luciferase depending upon the substitution pattern of R₂ and R₃.

In addition, compounds of Formula II may be used as the chemiluminescent agent.

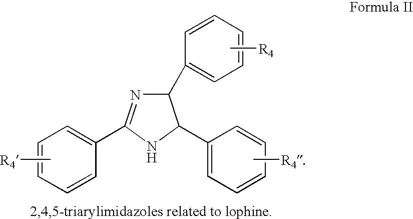

Each R₄ may independently be H, C₁-C₁₂ alkyl including linear, branched, or cyclic alkyl, C₁-C₁₂ alkoxyl including linear, branched, or cyclic alkoxyl, cyano, C₁-C₁₂ carboxy esters, C₁-C₁₂ ketones, or halogen except that halogen does not include iodine. The R₄ groups may be the same or different. R₄ cannot be nitro.

Further, compounds of Formula III may be used as the chemiluminescent agent.

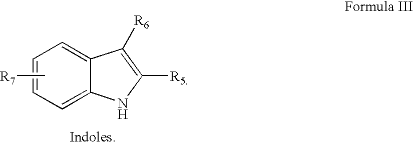

R₅ may be H, C₁-C₁₂ alkyl including linear, branched, or cyclic alkyl or aryl.

R₆ may be H, C₁-C₁₂ alkyl including linear, branched, or cyclic alkyl or aryl.

R₇ may be H, C₁-C₁₂ alkyl including linear, branched, or cyclic alkyl, aryl, C₁-C₁₂ alkoxy, or halogen but halogen may not be iodine. R₇ cannot be nitro.

Still further, compounds of Formula IV may be used as the chemiluminescent agent.

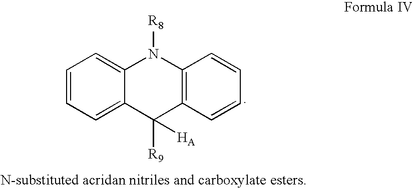

R₈ may be H, aryl, C₁-C₁₂ alkyl including linear, branched, or cyclic alkyl.

R₉ may be cyano or ester of the formula —COZ where Z may be a leaving group which in its protonated form has an acid constant (pKa) of 1×10⁻⁹ or higher, preferably 1×10⁻⁶ or higher. Several such leaving groups are known in the art and by way of illustration may include phosphate, phenol, thiophenol, aryl esters, and various heterocycles. R₈ may not be aliphatic esters.

Additionally, compounds of Formula V may be used as the chemiluminescent agent.

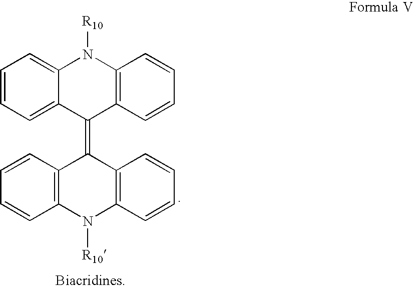

Each R₁₀ may independently be H, C₁-C₁₂ alkyl including linear, branched, cyclic alkyl, or aryl.

Other compounds of Formulas VI and Formula VII may be used as the chemiluminescent agent.

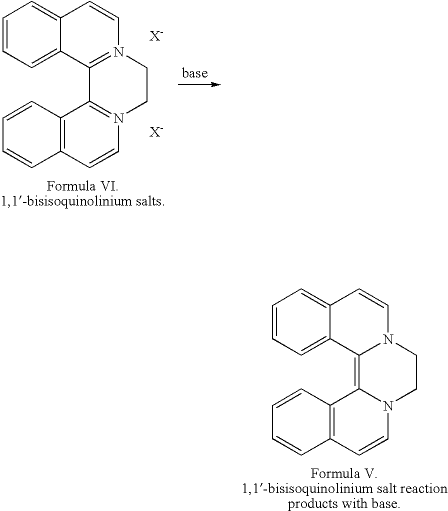

In Formula VI, X may be F, Br, or Cl. X may also be an anionic salt such as nitrate, citrate, sulfate.

Still other compounds of Formula VIII may be used as the chemiluminescent agent.

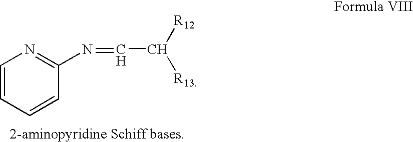

R₁₂ may be H, C₁-C₁₂ alkyl including linear, branched, cyclic alkyl, or aryl.

R₁₃ may be H, C₁-C₁₂ alkyl including linear, branched, cyclic alkyl, or aryl.

Further, compounds of Formula IX may be used as the chemiluminescent agent.

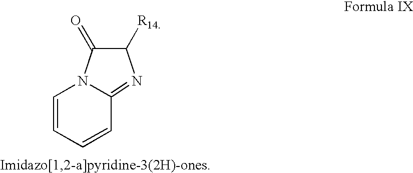

R₁₄ may be H, C₁-C₁₂ alkyl including linear, branched, cyclic alkyl, or aryl.

Other compounds of Formula X may be used as the chemiluminescent agent.

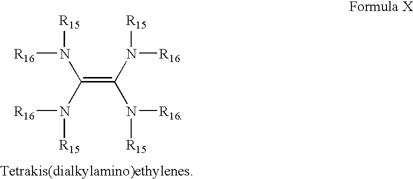

R₁₅ may be C₁-C₁₂ alkyl including linear, branched, or cyclic alkyl.

R₁₆ may be C₁-C₁₂ alkyl including linear, branched, or cyclic alkyl.

R₁₅ and R₁₆ may also be a part of a unitary ring system extending from the same nitrogen atom such as —(CH₂)₄—, or —(CH₂)₅—.

RIs and R₁₆ may also be a part of a unitary ring system extending from different nitrogen atoms (but those nitrogen atoms will be ipso to a common carbon) such as —(CH₂)₂—, or —(CH₂)₃—.

As can be seen from the above listed classes of compounds, a variety of compounds are available to serve as luminescent autoxidation substrates.

In some of the systems using the compounds selected from the group of Formulas I-X, strong base may be required to give rise to a triplet oxygen reactive carbanion. With respect to tetrakis(dialkylamino)ethylenes, no added base is required and the chemiluminescent agent can spontaneously reacts with triplet oxygen.

In all of the different Formulas aforementioned, it is contemplated that only those functional groups designated by Rₙ, X, or Z that do not interfere with the luminescence property be utilized in the projectiles.

In still another aspect of the invention, a method for manufacturing a luminescent projectile comprising the steps of preparing a fill material, the fill material comprising a chemiluminescent substrate and a solvent, preparing a frangible shell and filling the frangible shell with the fill material is disclosed.

In yet another aspect of the invention, a method of marking an object comprising the steps of impacting a target with a frangible projectile that breaks upon impact releasing a chemiluminescent substrate to expose the chemiluminescent substrate an oxidation source is disclosed.

A good light emitting paint ball should be economical to manufacture using standard encapsulating equipment commonly available to the industry. The projectiles should not be too brittle or too soft and should be usable in existing paint ball markers without modification. The marking material should be clearly visible on impact for several seconds to minutes and should possess the other desirable properties generally expected with fillers commonly used in the industry, i.e., washability, target surface adhesion, low splatter radius, and good marking properties. In addition, the luminescent projectiles should have good ballistic properties, good shelf life, and should produce a luminescent mark which is clearly visible for several minutes under low light as well as dark conditions.

In practice, a chemiluminescent composition suitable for autoxidation is prepared by dissolving or dispersing one or more of the compounds selected from the group of Formulas I-X in an appropriate carrier, the combination being called a fill material. Many fill materials may include other ingredients compatible with one or more of the chemiluminescent autoxidation systems described above. Carrier for the chemiluminescent agents may include:

a solvent, such as mineral oil, polyethylene glycol, silicone oil, vegetable oil, or the like, which allows dissolution and/or dispersion of the luminescent agent and other ingredients;

a thickening agent, such as candelilla wax, paraffin wax, virgin paraffin wax, petrolatum, polysorbitol, microcrystalline wax or the like, which provides the bulk needed for the projectile and the ability to maintain solids suspension; and

a pigment, such as alumina, barium oxide, iron oxide, silica, titanium dioxide, zinc oxide, or the like, which provides a clearly visible spot. Many pigments are known to one skilled in the art and many of which could augment the illustrative list. It is desirable to have a pigment with a high surface area. With respect to titanium oxide pigments, rutile, antase and mixtures of rutile and anatase crystal forms may be used. It is preferred that the pigment reflect or scatter light for enhance illumination effects. Pigments like titanium dioxide enhance the application of the chemiluminescent agents use in daytime light conditions.

Another feature associated with the selection and concentration of the thickening agent in the compositions of the invention influences the surface area of the impacted paintball. Thicker mixtures will result in smaller surface areas and slower reaction times. This may be desirable if marking of a target is expected to be prolonged over a sustained time. In the alternative, thinner mixtures will result in larger surface areas and quicker reaction times. This may be desirable if marking of a target is expected to produce a more intense and shorter burst of light.

Still another feature of the invention arises from incorporating a hydrophobic solvent into the paint material. Hydrophobic solvents will aid in repelling absorption of water through the paintball shell.

Aside from the carrier, the fill material may be supplemented with one or more of the following ingredients depending on the specific luminescent agent or the desired property:

an activator, such as alkyl alcohols or alkyl polyols including but not limited to iso-butanol, t-butanol, ethylene glycol, ethylhexanol, n-octanol, iso-octanol, n-decanol, n-hexadecanol, or the like, which enhances light output of the luminescent agent and may help transport an oxidant such as atmospheric oxygen to the chemiluminescent agent. Water may also serve as an activator, but is not preferred as it also can quench the light-producing reaction. In some instances, the activator may also be a surfactant, particularly when the surfactant has hydroxyl groups;

a surfactant, such as Rhodacal® reagents (alkyl, arylalkyl sulfonate surfactants, commercially available from Rhodia Chimie Corp.), Rhodasurf™ reagents (alcohol ethoxylate surfactants, commercially available from Rhodia Chimie Corp.), stearic acid, Tween™ reagents (sorbitan esters of stearic acid, commercially available from Sigma-Aldrich Co.), and the like, which allows added convenience in washing the fill material from an impact site after it has been used as a paint ball or to improve solubility and dispersion properties;

a solids suspending agent, such as starch, cellulose, fumed silica, talc, or the like, which allows for the pigment and other solids to maintain suspension in the fill material;

a dye, such as FD&C yellow, blue, or red, phthalocyanine green, or phthalocyanine blue, or the like;

a preservative or stabilizing agent, such as calcium chloride, calcium sulfate, lithium aluminum hydride, lithium bromide, lithium chloride, magnesium sulfate, sodium borohydride, sodium sulfate, or the like which enhances long term stability of the fill material, other electron rich additives such as vitamins and antioxidants; and

a fragrance such as peppermint, spearmint, pinene including α-pinene and β-pinene, limonene and the like. The fragrance can also serve to act as an indicator to the target that he or she has been struck. The fragrance may dually serve to mask undesirable odors inherently present in the filler material before or after autoxidation. Additional examples of fragrances include amyl acetate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, camphor gum, carvacrol, laevo-carveol, d-carvone, laevo-carvone, citral (neral), citronellol, citronellyl acetate, citronellyl isobutyrate, citronellyl nitrile, citronellyl propionate, para-cresol, para-cresyl methyl ether, cyclohexyl ethyl acetate, cuminic alcohol, cuminic aldehyde, cyclal C (3,5-dimethyl-3-cyclohexene-1-carboxaldehyde), para-cymene, decyl aldehyde, dimethyl benzyl carbinol, dimethyl octanol, diphenyl oxide, dodecalactone, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl alcohol, geraniol, geranyl nitrile, hexenol, β γ hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, α-irone, isoamyl alcohol, isobutyl benzoate, isomenthone, isononyl acetate, isononyl alcohol, isobutyl quinoline, isomenthol, para-isopropyl phenylacetaldehyde, isopulegol, isopulegyl acetate, isoquinoline, cis-jasmone, lauric aldehyde (dodecanal), ligustral (2,4-dimethyl-3-cyclohexene-1-carboxaldehyde), linalool, linalool oxide, menthone, methyl acetophenone, para-methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, methyl nonyl acetaldehyde, methyl octyl acetaldehyde, methyl salicylate, myrcene, neral, nerol, γ-nonalactone, nonyl acetate, nonyl aldehyde, allo-ocimene, octalactone, octyl alcohol (2-octanol), octyl aldehyde, (d-limonene), phenoxy ethanol, phenyl acetaldehyde, phenyl ethyl acetate, phenyl ethyl alcohol, phenyl ethyl dimethyl carbinol, propyl butyrate, rose oxide, 4-terpinenol, α-terpineol, terpinolene, tonalid (6-acetyl-1,1,3,4,4,6-hexamethyl tetrahydronaphthalene), undecenal, veratrol (ortho-dimethoxybenzene). Nonlimiting examples of perfume ingredients that have a significantly low detection threshold, useful in the composition of the present invention, are, ambrox (1,5,5,9-tetramethyl-1,3-oxatricyclotridecane), anethole, bacdanol (2-ethyl-4-(2,2,3-trimethyl-3-cyclopenten-1-yl)-2-buten-1-o1), benzyl acetone, benzyl salicylate, butyl anthranilate, calone, cetalox (2-ethyl-4-(2,2,3-trimethyl-3-cyclopenten-1-yl)-2-buten-1-ol), cinnamic alcohol, coumarin, Cyclal C (3,5-dimethyl-3-cyclohexene-1-carboxaldehyde), cymal (2-methyl-3-(para isopropylphenyl)propionaldehyde), 4-decenal, dihydro isojasmonate, γ-dodecalactone, ebanol, ethyl anthranilate, ethyl-2-methyl butyrate, ethyl vanillin, eugenol, florhydral (3-(3-isopropylphenyl)butanol), fructone (ethyl-2-methyl-1,3-dioxolane-2-acetate), heliotropin, herbavert (3,3,5-trimethylcyclohexyl-ethyl ether), cis-3-hexenyl salicylate, indole, iso cyclo citral, isoeugenol, a-isomethylionone, keone, lilial (para-tertiary butyl α-methyl hydrocinnamic aldehyde), linalool, lyral (4-(4-hydroxy-4-methyl-pentyl).sub.3-cylcohexene-1-carboxaldehyde), methyl heptine carbonate, methyl anthranilate, methyl dihydrojasmonate, methyl isobutenyl tetrahydropyran, methyl β naphthyl ketone, methyl nonyl ketone, β naphthol methyl ether, nerol, para-anisic aldehyde, para hydroxy phenyl butanone, phenyl acetaldehyde, y-undecalactone, undecylenic aldehyde, vanillin, and mixtures thereof. Preferred fragrances are the terpenes and more preferred fragrances are pinene and limonene.

The projectile or paint ball consists of a plasticized frangible capsule that forms a chamber containing the marking composition or paint. A properly designed and manufactured projectile is capable of being launched without breakage and yet is capable of fragmentation upon impact with the target without causing serious harm or damage to the target.

Projectiles made with a carrier and other optional filler materials may also be encapsulated within a plasticized frangible outer capsule to provide a hard outer wall with materials known to one skilled in the art. In particular, gelatin shells used in present paint ball systems are preferred. The outer wall of the encapsulating shell protects or isolates its contents from oxygen and other elements or forces. Many encapsulating materials have been found to be compatible with one or more of the described chemiluminescent autoxidation systems. An example of such an encapsulating material comprises gelatin, hydrocarbon polymer, such as polyacrylate, polyethylene, polystyrene, polyvinyl alcohol, or the like, water, and one or more plasticizers, such as diethylene glycol, glucose, glycerine, mineral oil, parabens, starch, polyglycerol, sorbitol, or the like, added to create the appropriate shape, durability for firing from a projectile launcher and frangibility needed to break on impact with the target. Another encapsulating material comprises gelatin, a carbohydrate like material such as the reduced sugars sorbitol, mannitol, xylitol, glycerin and the like and mixtures of the same, and water. The gelatin component may be obtained from a variety of sources including bloom pork skin.

Projectile shells made with carbohydrate polymers like gelatin for use during cold periods are typically made with less water while shells made for use during warm periods are typically made with relatively more water. Furthermore, preparation of the projectiles should be done in an oxygen-free atmosphere so as to preserve the chemical light capacity of the chemiluminescent agent.

The selection of the chemiluminescent agent and/or dye, or pigment may also be used in a game or exercise to identify an individual or team. Each individual or team may be supplied with chemiluminescent paint balls containing distinctive non-chemiluminescent materials to distinguish individuals or team members. Such non-chemiluminescent materials include pigments such as alumina, barium oxide, iron oxide, silica, titanium dioxide, zinc oxide. The respective color can then be used to identify the source of hits by the corresponding person or team. In addition, each individual or team may be supplied with chemiluminescent paint balls containing distinctive chemiluminescent materials to distinguish individuals or team members. The respective color can then be used to identify the source of hits by the marker.

Another feature of using the chemiluminescent agents in a single-chamber shell inures from a stealth feature afforded to the person firing the projectile. Because the chemiluminescent reagents do not react until the shell is compromised by impacting on a target, the location of the person firing the marker remains uncertain. There is no tracer associated with the paint ball as it travels between the marker and the impact site. This allows the person firing the marker to remain undetected.

In one aspect of the invention, a method for manufacturing a luminescent projectile is disclosed comprising the steps of preparing a fill material, the fill material comprising a chemiluminescent substrate and a solvent, preparing a frangible shell and filling the frangible shell with a fill material.

In another aspect of the invention, a method of marking an object is disclosed comprising the steps of impacting a target with a frangible projectile that breaks upon impact releasing a chemiluminescent substrate to expose the chemiluminescent substrate to an oxidation source. The oxidation source can be atmospheric oxygen. In the alternative, the oxidation source may be optionally contained in the projectile in a first compartment reactively separate from the chemiluminescent substrate, wherein the first compartment becomes reactively connected to the chemiluminescent substrate upon impact. In another alternative, the oxidation source is selected from the group consisting of hydrogen peroxide, alkyl peroxide and aryl peroxide.

In yet another aspect of the invention, a method of playing a paintball game is disclosed including the steps of dividing two or more people into a first team and second team of players wherein each player has a marker for discharging paintballs, the paintballs comprising a chemiluminescent agent, a solvent; and a shell surrounding the chemiluminescent agent and the solvent, providing a playing surface with a first point and a second point, positioning the first team near the first point, the first team having the objective to score points by marking players of the second team, positioning the second team near the second point, the second team having the objective to score points by marking players of the first team, awarding a point value to the first team each time a player from the first team marks a player from the second team and awarding a point value to the second team each time a player from the second team marks a player from the first team, and, determining a winning team based on which of the first team and the second team accumulates the largest point total over a predetermined game time.

Additionally, the method of playing a paint ball game can modified in several aspects. For example, the playing surface can include a plurality of end lines which divides the playing surface into a plurality of zones. Teams then may optionally have another objective to score points by carrying team flags to respective goal points which may be positioned near first and second starting points without being marked by a player from another team. Point values are awarded to a team each time a player reaches a goal carrying a team flag. The point value from carrying a flag to a goal may vary based upon the zone in which the team flag is located when the first team reaches a goal. Preferably the point value awarded to a team increases the further the team flag is from the respective goal. Optionally, the game may include the step of removing one or more players from the playing surface a player is marked by one or more paintballs. In some examples, the method of playing can be carried out within a building. In other examples, the method of playing can be carried out in the outdoors.

In another aspect of the invention, a method of playing paint ball comprising using a single chamber shell with an autooxidative chemiluminescent agent is disclosed.

In another aspect of the invention, chemiluminescent compositions are provided and may be characterized as including a chemiluminescent agent of from about 5% to about 10%, wax of from about 2% to about 5%, a pigment of from about 0% to about 10%, a fragrance additive of from about 0% to about 3%, an organic alcohol of from about 0% to about 3%, a hydrophobic solvent of from about 70% to about 90%, and a surfactant of from about 0% to about 3%.

### EXAMPLES

The following examples provided are in no way intended as limiting and serve only to illustrate a variety of compounds, carriers, fill materials and capsules, that are available. There are certainly a variety of additional compounds, which could serve equally well.

### Examples of Oxidative Luminescent Compounds

### Example 1

Tetrakis(dimethylamino)ethylene (Formula X, where R₁₅ and R₁₆═—CH₃) can be prepared as described in U.S. Pat. No. 3,824,289 by reacting excess chlorotrifluoroethylene and dimethylamine under pressure. Product is isolated after extraction with aqueous alkali and water removal. Product is luminescent on exposure to air.

### Example 2

Tetrakis(pyrrolidinyl)ethylene (Formula X, where R₁₅ and R₁₆═—(CH₂)₄—) was prepared by combining 6 parts of dimethylformamide dimethyl acetal with 7 parts of pyrrolidine and heated to 110° C. as by-products were collected by distillation. After about 4 hours, the mixture was heated to 200° C. for about 2 hours as by-products were collected by distillation. The mixture was cooled and solid product was collected from acetonitrile. Product was luminescent on exposure to air.

### Example 3

Tetrakis(piperidinyl)ethylene (Formula X, where R₁₅ and R₁₆═—(CH₂)₅—) was prepared by combining 3 parts of dimethylformamide dimethyl acetal with 4 parts of piperidine and heated to 110° C. as by-products were collected by distillation. After about 4 hours, the mixture was heated to 200° C. for about 2 hours as by-products were collected by distillation. The mixture was cooled and solid product was collected from acetonitrile.

### Example 4

Tetrakis(morpholinyl)ethylene (Formula X, where R₁₅ and R₁₆═—(CH₂)₂O(CH₂)₂—) was prepared by combining 3 parts of dimethylformamide dimethyl acetal with 4 parts of morpholine and heated to 110° C. as by-products were collected by distillation. After about 4 hours, the mixture was heated to 200° C. for about 2 hours as by-products were collected by distillation. The mixture was cooled and solid product was collected from ethyl acetate.

### Example 5

Bimethylimidazolidene ethylene was prepared by combining 5 parts of N,N′methylethylenediamine (Formula X, where R₁═—CH₃, and R₂═—(CH₂)₂—) and 6 parts of dimethylformamide dimethyl acetal and heating the solution to about 150° C. for about 4 hours during which time, by-products are collected by distillation. The resulting mixture was cooled and distilled to give 4 parts of product. Product was luminescent on exposure to air.

### Example 6

Bis(1,3-diphenylimidazolidine) (Formula X, where R₁₅═—C₆H₅, and R₁₆═—(CH₂)₂—) was prepared by combining 1 part of N,N′-diphenylethylenediamine and 5 parts of triethyl orthoformate and heating the solution to about 200° C. for about 4 hours during which time, by-products are collected by distillation. The resulting mixture was cooled, filtered and washed with ether to give 1 part of product. Product was luminescent on exposure to air.

### Example 7

2,2′-Ethylene-1,1′-biisoquinolylidene (VII) can be prepared as described by Maeda et al. in J. Chem. Soc. Perkin Trans 2, 1996, p. 121-126 by heating 1,1′-biisoqunoline with 1,2-dibromoethane for 4 hours. Salt of the product is isolated by filtering, washing with dimethylformaldehyde (DMF) and recrystallizing with methanol. An aqueous solution of the salt is treated with excess Na₂S₂O₄ and Na₂CO₃ and extracted with chloroform to give product. When exposed to air the solution will be luminescent.

### Example 8

2-Aminopyridine Schiff base (Formula VIII, where R₁₂, and R₁₃═—CH₃) can be prepared as described by Channon et al. in Chemical Communications, 1969, p. 92-93 by heating 2-aminopyridine and isobutyraldehyde in toluene with p-toluene sulfonic acid as catalyst. The product will be luminescent on exposure to air, dimethyl sulfoxide, and potassium t-butoxide.

### Examples of Fill Mixtures

### Example 9

Tetrakis(dimethylamino)ethylene (Formula X, where R₁₅ and R₁₆═—CH₃), 1 part, and heavy mineral oil, 9 parts, were combined under an argon atmosphere. The resulting mixture luminesced brightly on exposure to air.

### Example 10

Tetrakis(dimethylamino)ethylene (Formula X, where R₁₅ and R₁₆═—CH₃) 1 part, and polyethylene glycol, 9 parts, were combined under an argon atmosphere. The resulting mixture luminesced brightly on exposure to air.

### Example 11

Tetrakis(pyrrolidinyl)ethylene (Formula X, where R₁₅ and R₁₆═—(CH₂)₄—), 1 part, and heavy mineral oil were combined, 9 parts, under an argon atmosphere. The resulting mixture luminesced brightly on exposure to air.

### Example 12

Tetrakis(pyrrolidinyl)ethylene (Formula X, where R₁₅ and R₁₆═—(CH₂)₄—), 1 part, and polyethylene glycol, 9 parts, were combined under an argon atmosphere. The resulting mixture luminesced brightly on exposure to air.

### Example 13

Tetrakis(pyrrolidinyl)ethylene (Formula X, where R₁₅ and R₁₆═—(CH₂)₄—), 1 part, and silicone oil, 9 parts, were combined under an argon atmosphere. The resulting mixture luminesced brightly on exposure to air.

### Example 14

Tetrakis(dimethylamino)ethylene (Formula X, where R₁₅ and R₁₆═—CH₃), 1 part, heavy mineral oil, 7 parts, and titanium dioxide, 2 parts, were combined under an argon atmosphere. The resulting mixture luminesced brightly on exposure to air.

### Example 15

Tetrakis(dimethylamino)ethylene (Formula X, where R₁₅ and R₁₆═—CH₃), 1 part, light mineral oil, 7 parts, and titanium dioxide, 2 parts, were combined under an argon atmosphere. The resulting mixture luminesced brightly on exposure to air.

### Example 16

Tetrakis(dimethylamino)ethylene (Formula X, where R₁₅ and R₁₆═—CH₃), heavy mineral oil, 5 parts, polyethylene glycol, 2 parts, and titanium dioxide, 2 parts, were combined under an argon atmosphere. The resulting mixture luminesced brightly on exposure to air.

### Example 17

Tetrakis(pyrrolidinyl)ethylene (Formula X, where R₁₅, and R₁₆═—(CH₂)₄—), 1 part, heavy mineral oil, 5 parts, polyethylene glycol, 2 parts, and titanium dioxide, 2 parts, were combined under an argon atmosphere. The resulting mixture luminesced brightly on exposure to air.

### Example 18

Heavy mineral oil, 69 parts, thickener (paraffin wax), 6 parts, and activator (1-octanol), 0.5 parts, were combined and heated enough to create a solution. This was allowed to stand overnight. To this mixture, titanium dioxide, 15 parts, and tetrakis(pyrrolidinyl)ethylene (Formula X, where R₁₅ and R₁₆═—(CH₂)₄—), 10 parts, were added under an argon atmosphere. The resulting thick paint-like mixture luminesced brightly on exposure to air.

### Example 19

Heavy mineral oil, 59 parts, thickener (paraffin wax), 6 parts, surfactant (Rhodasurf® DA-630), 10 parts, and activator (1-octanol), 0.5 parts, were combined and heated enough to create a solution. This was allowed to stand overnight. To this mixture, titanium dioxide, 15 parts, and tetrakis(pyrrolidinyl)ethylene (Formula X, where R₁₅ and R₁₆═—(CH₂)₄—), 10 parts, were added under an argon atmosphere. The resulting thick paint-like mixture luminesced brightly on exposure to air.

### Example 20

Polyethylene glycol, 58 parts, heavy mineral oil, 5 parts, surfactant (2-(2-octadecyloxyethoxy)ethanol), 3 parts, thickener 1 (paraffin wax), 3 parts, and thickener 2 (poly(ethylene glycol)distearate), 3 parts, were combined and heated enough to create a solution. The resulting solution was allowed to cool to room temperature and stand overnight. To this, titanium dioxide, 20 parts, and thickener, 3 parts, were added. This was again allowed to stand overnight. To this mixture, tetrakis(dimethylamino) ethylene (Formula X, where R₁₅ and R₁₆═—CH₃), 4 parts, was added under an argon atmosphere. The resulting thick paint-like mixture luminesced brightly on exposure to air.

### Example 21

Heavy mineral oil, 37 parts, surfactant ((octadecyloxyethoxy) ethanol), 5 parts, thickener 1 (paraffin wax), 4 parts, thickener 2 (soluble starch), 5 parts, thickener 3 (poly(ethyleneglycol)distearate), 2 parts, activator 1 (t-butanol), 2 parts, and activator 2 (1,3-butanediol), 2 parts, were combined and heated enough to create a solution. This was allowed to stand overnight. To this mixture, titanium dioxide, 15 parts, zinc sulfide, 5 parts, and tetrakis(dimethylamino)ethylene (Formula X, where R₁₅ and R₁₆═—CH₃), 2 parts, were added under an argon atmosphere. The resulting thick paint-like mixture luminesced brightly on exposure to air.

### Example 22

Heavy mineral oil, 54 parts, thickener (paraffin wax), 6 parts, surfactant (Rhodasurf® D DA-630), 10 parts, and activator (1-octanol), 0.5 parts, were combined and heated enough to create a solution. This was allowed to stand overnight. To this mixture, titanium dioxide, 15 parts, fumed silica, 5 parts, and tetrakis(pyrrolidmyl)ethylene (Formula X, where R₁₅ and R₁₆═—(CH₂)₄—), 10 parts, were added under an argon atmosphere. The resulting thick paint-like mixture luminesced brightly on exposure to air.

### Example 23

Heavy mineral oil, 76.5 parts, thickener (virgin paraffin wax), 3.5 parts, and activator (1-octanol), 1 part, were combined and heated enough to create a solution. This solution was allowed to stand overnight. To this mixture, titanium dioxide, 11 parts, and tetrakis(pyrrolidinyl)ethylene (Formula X, where R₁₅ and R₁₆═—(CH₂)₄—), 8 parts, were added under an argon atmosphere. The resulting thick paint-like mixture luminesced brightly on exposure to air.

### Examples of Projectiles

The gelatin shell materials in the examples below were prepared using a melt containing gelatin (43-60%), water (30-35%), glycerin (5-10%), sorbitol (5-10%), and dye (<2%).

### Example 24

Fill mixture was prepared as in Example 12 and encapsulated into a thin spherical gelatin shell. The resulting projectile was fired from a paint ball gun and luminesced brightly when crushed.

### Example 25

Fill mixture was prepared as in Example 18 and encapsulated into a thin spherical gelatin shell. The resulting projectile was fired from a paint ball gun and luminesced brightly when crushed.

### Example 26

Fill mixture was prepared as in Example 19 and encapsulated into a thin spherical gelatin shell. The resulting projectile was fired from a paint ball gun and luminesced brightly when crushed.

### Example 27

Fill mixture was prepared as in Example 20 and encapsulated into a thin spherical gelatin shell. The resulting projectile was fired from a paint ball gun and luminesced brightly when crushed.

### Example 28

Fill mixture was prepared as in Example 21 and encapsulated into a thin spherical gelatin shell. The resulting projectile was fired from a paint ball gun and luminesced brightly when crushed.

### Example 29

Fill mixture was prepared as in Example 22 and encapsulated into a thin spherical gelatin shell. The resulting projectile was fired from a paint ball gun and luminesced brightly when crushed.

### Example 30

Fill mixture was prepared as in Example 23 and encapsulated into a thin spherical gelatin shell. The resulting projectile was fired from a paint ball gun and luminesced brightly when crushed.

### Example 31

A gelatin shell was also prepared using a melt containing gelatin (49%), water (31%), glycerin (3.5%), and maltitol (16.5%). The shells were allowed to dry for 15 hours after being filled.

### Example 32

A gelatin shell was also prepared using a melt containing gelatin (54%), water (26%), glycerin (3.5%), and maltitol (16.5%). The shells were allowed to dry for 15 hours after being filled.

### Example 33

The shell of example 31 was filled with a fluid made up of tetrakis(pyrrolidinyl)ethylene (7%), microscrystalline wax C-160 (Cal-Wax, Irwindale, Calif.) (3.8%), titanium dioxide R-FC6 (Huntsman Tioxide) (5%), β-pinene (Sigma-Aldrich Co.) (1%), 2-octanol (Sigma-Aldrich Co.) (0.8%) Duoprime® 350 (mineral oil, Citgo) (81.4%), Rhodasurf® DA 630 (Rhodia Chimie Corp.) (1%).

### Example 34

The shell of example 32 was filled with a fluid made up of tetrakis(pyrrolidinyl)ethylene (7%), microscrystalline wax C-160 (Cal-Wax, Irwindale, Calif.) (3.8%), titanium dioxide R-FC6 (Huntsman Tioxide) (5%), β-pinene (Sigma-Aldrich Co.) (1%), 2-octanol (Sigma-Aldrich Co.) (0.8%) Duoprime® 350 (mineral oil, Citgo) (81.4%) and Rhodasurf® DA 630 (Rhodia Chimie Corp.) (1%).

While the compounds have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The compounds described herein are to be considered in all respects as only illustrative, and not restrictive. All changes which come within the meaning and range of equivalency of the claims are to be embraced within their scope.

What is claimed is:

1. A projectile which illuminates a target on impact comprising:
an autoxidative chemiluminescent agent;
a solvent; and,
a single chamber frangible shell surrounding the chemiluminescent agent and the solvent and capable of dispersing the chemiluminescent agent to react with atmospheric oxygen.

2. The projectile of claim 1 wherein the chemiluminescent agent is selected from the group consisting of benzothiazoles, 2,4,5-triarylimidazoles, indoles, N-substituted acridan nitrites and carboxylate esters, biacridines, 1,1′-bisisoquinolimum quaternary salts, products of 1,1′-bisisoquinolinium quaternary salts reaction with base, 2-aminopyridine Schiff bases, inidazo[1,2-a]pyridine-3(2H)-ones, and tetrakis(dialkylamino)ethylenes.

3. The projectile of claim 1 wherein the chemiluminescent agent is selected from the group consisting of compounds of Formulas I-IX,. 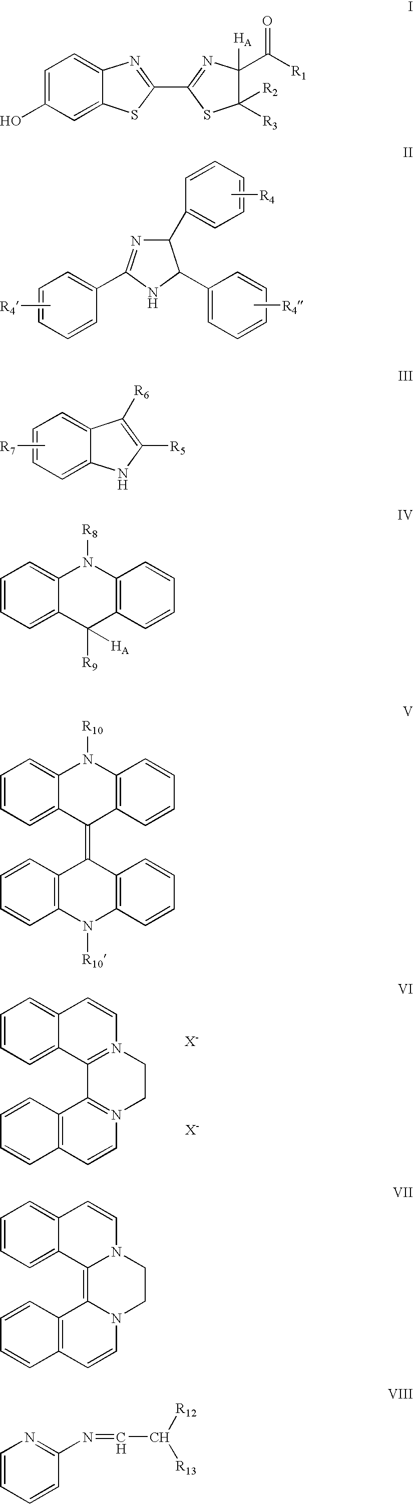 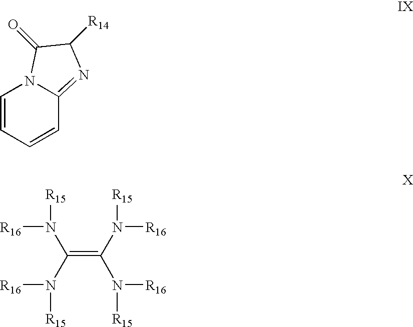
in which the individual radicals have the following meanings:
R₁ may be a leaving group which in its protonated form has an acid constant (pKa) of 1×10⁻⁹ or greater but not aliphatic esters;
R₂ may be H, and C₁-C₁₂ hydrocarbon including linear, branched, or cyclic hydrocarbon, aryl, benzyl, unsaturated hydrocarbon, alkoxyl, or halogen but halogen does not include iodine;
R₃ may be H, and C₁-C₁₂ hydrocarbon including linear, branched, or cyclic hydrocarbon, aryl, benzyl, unsaturated hydrocarbon, alkoxyl, or halogen but halogen does not include iodine;
each R₄ may independently be H, C₁-C₁₂ alkyl including linear, branched, or cyclic alkyl, C₁-C₁₂ alkoxyl including linear, branched, or cyclic alkoxyl, cyano, C₁-C₁₂ carboxy esters, C₁-C₁₂ ketones, or halogen except that halogen does not include iodine, and R₄ cannot be nitro;
R₅ may be H, C₁-C₁₂ alkyl including linear, branched, or cyclic alkyl or aryl;
R₆ may be H, C₁-C₁₂ alkyl including linear, branched, or cyclic alkyl or aryl;
R₇ may be H, C₁-C₁₂ alkyl including linear, branched, or cyclic alkyl, aryl, C₁-C₁₂ alkoxy, or halogen but halogen may not be iodine, and R₇ cannot be nitro;
R₈ may be H, aryl, C₁-C₁₂ alkyl including linear, branched, or cyclic alkyl;
R₉ may be cyano or ester of the formula —COZ wherein Z may be a leaving group which in its protonated form has an acid constant (pKa) of 1×10⁻⁹ or higher, preferably 1×10⁻⁶ or higher. Several such leaving groups are known in the art and by way of illustration may include phosphate, phenol, thiophenol, aryl esters, and various heterocycles, but R₈ may not be aliphatic esters;
each R₁₀ may independently be H, C₁-C₁₂ alkyl including linear, branched, cyclic alkyl, or aryl;
R₁₂ may be H, C₁-C₁₂ alkyl including linear, branched, cyclic alkyl, or aryl;
R₁₃ may be H, C₁-C₁₂ alkyl including linear, branched, cyclic alkyl, or aryl;
R₁₄ may be H, C₁-C₁₂ alkyl including linear, branched, cyclic alkyl, or aryl;
R₁₅ may be C₁-C₁₂ alkyl including linear, branched, or cyclic alkyl; and,
R₁₆ may be C₁-C₁₂ alkyl including linear, branched, or cyclic alkyl.

4. The projectile of any of claims 1, 2 and 3 wherein the chemiluminescent agent is tetrakis(pyrrolidinyl)ethylene.

5. The projectile of claim 1 wherein the solvent is selected from mineral oil, polyethylene glycol, silicone oil, vegetable oil and mixtures of the foregoing.

6. The projectile of claim 1 further comprising an activator.

7. The projectile of claim 6 wherein the activator is selected from organic alcohols and water.

8. The projectile of claim 6 wherein the activator is selected from iso-butanol, tert-butanol, ethylene glycol, ethylhexanol, n-octanol, iso-octanol, n-decanol, n-hexadecanol and mixtures of the foregoing.

9. The projectile of claim 1 further comprising a pigment.

10. The projectile of claim 9 wherein the pigment is selected from alumina, barium oxide, iron oxide, silica, titanium dioxide, zinc oxide and mixtures of the foregoing.

11. The projectile of claim 9 wherein the pigment is selected from FD&C yellow, blue and red, phthalocyanine green, phthalocyanine blue, and mixtures of the foregoing.

12. The projectile of claim 1 further comprising a surfactant.

13. The projectile of claim 1 further comprising a thickening agent.

14. The projectile of claim 13 wherein the thickening agent is selected from microcrystalline wax, candelilla wax, paraffin wax, virgin paraffin wax, petrolatum, polysorbitol and mixtures of the foregoing.

15. The projectile of claim 1 further comprising a fragrance.

16. The projectile of claim 15 wherein the perfume is selected from peppermint, spearmint, terpenoids, β-pinene, limonine, and mixtures of the foregoing.

17. The projectile of any of claims 1, 2, and 3 wherein the chemiluminescent agent is capable of a luminescent quantum yield in the range of 1 to 0.00001 Einsteins per mole.

18. The projectile of any of claims 1, 2, 3, and 17 wherein the chemiluminescent agent is capable of a luminescent quantum yield in the range of 1 to 0.001 Einsteins per mole.

19. A method for manufacturing a luminescent projectile comprising the steps of:
preparing a fill material, the fill material comprising a chemiluminescent substrate and a solvent;
preparing a frangible shell;
filling the frangible shell with the fill material.

20. A method of marking an object comprising the steps of
impacting a target with a frangible projectile that breaks upon impact releasing a chemiluminescent substrate to expose the chemiluminescent substrate to an oxidation source,

21. The method of claim 20 wherein the oxidation source is atmospheric oxygen.

22. A method as in claim 20 wherein the oxidation source is contained in the projectile in a first compartment reactively separate from the chemiluminescent substrate, wherein the first compartment becomes reactively connected to the chemiluminescent substrate upon impact.

23. A method as in claim 20, wherein the oxidation source is selected from the group consisting of hydrogen peroxide, alkyl peroxide and aryl peroxide.

24. A method of playing a paintball game comprising the steps of dividing two or more people into a first team and second team of players wherein each player has a marker for discharging paintballs, the paintballs comprising a chemiluminescent agent, a solvent; and a shell surrounding the chemiluminescent agent and the solvent;
providing a playing surface with a first point and a second point;
positioning the first team near the first point, the first team having the objective to score points by marking players of the second team;
positioning the second team near the second point, the second team having the objective to score points by marking players of the first team;
awarding a point value to the first team each time a player from the first team marks a player from the second team and awarding a point value to the second team each time a player from the second team marks a player from the first team; and,
determining a winning team based on which of the first team and the second team accumulates the largest point total over a predetermined game time.

25. The method of claim 24 wherein the playing surface further includes a plurality of end lines, the playing surface being divided into a plurality of zones, the first team further having another objective to score points by carrying a first team flag to a first goal positioned near the first point without being marked by a player from the second team, the second team further having another objective to score points by carrying a second team flag through to a second goal positioned near the second point without being marked by a player from the first team, further comprising the steps of:
awarding a point value to the first team each time a player from the first team reaches the first goal carrying the first team flag, the point value being based upon the zone in which the first team flag is located when the first team reaches the first goal, and wherein the point value awarded to the first team increases the further the first team flag is from the first goal; and,
awarding a point value to the second team each time a player from the second team reaches the second goal carrying the second team flag, the point value being based upon the zone in which the second team flag is located when the second team reaches the second goal, and wherein the point value awarded to the second team increases the further the second team flag is from the second goal.

26. The method of claim 24 further comprising the step of removing one or more players from the playing surface when the player is marked by one or more of the paintballs.

27. The method of any of claims 24, 25, and 26 wherein the playing surface is outdoor.

28. The method of any of claims 24, 25, and 26 where the playing surface is located within a building.

29. A method of playing paint ball comprising using a single chamber shell with an autooxidative chemiluminescent agent.

30. A composition for chemiluminescence comprising:
a chemiluminescent agent of from about 5% to about 10%;
a wax of from about 2% to about 5%;
a pigment of from about 0% to about 10%;
a fragrance additive of from about 0% to about 3%;
an organic alcohol of from about 0% to about 3%;
a hydrophobic solvent of from about 70% to about 90%; and,
a surfactant of from about 0% to about 3%.

31. A projectile consisting of single frangible chamber, wherein the chamber contains ingredients comprising an autoxidative chemiluminescent agent and a solvent.

32. The projectile of claim 31 wherein said autoxidative chemiluminescent agent reacts with atmospheric oxygen upon impact with a target.
